(19) United States
(12) Patent Application Publication
(10) Pub. No.: US 2026/0003564 A1
(43) Pub. Date: Jan. 1, 2026

(54) WIRELESS AUDIO DEVICE AND OPERATING METHOD THEREOF

(71) Applicant: Samsung Electronics Co., Ltd., Suwon-si (KR)

(72) Inventors: Jaemo YANG, Suwon-si (KR); Yeongkwan KIM, Suwon-si (KR); Moa LEE, Suwon-si (KR); Jeonghwan CHOI, Suwon-si (KR); Hangil MOON, Suwon-si (KR)

(21) Appl. No.: 19/203,540

(22) Filed: May 9, 2025

Related U.S. Application Data
(63) Continuation of application No. PCT/KR2025/004616, filed on Apr. 4, 2025.

(30) Foreign Application Priority Data
Jun. 27, 2024 (KR) 10-2024-0084811
Jul. 9, 2024 (KR) 10-2024-0090563
Jul. 23, 2024 (KR) 10-2024-0097244

(51) Int. Cl. G06F 3/16; H04R 1/10; H04R 1/40

(52) U.S. Cl. CPC G06F 3/165; H04R 1/1083; H04R 1/406

(57) ABSTRACT

A wireless audio device including two or more earpieces is provided. Each of the earpieces includes one or more microphones configured to obtain an ambient audio signal from outside of the wireless audio device, a speaker configured to output at least one of the obtained ambient audio signal or an audio content, memory storing one or more computer programs, and one or more processors communicatively coupled to the one or more microphones, the speaker, and the memory, and wherein the one or more computer programs include computer-executable instructions that, when executed by the one or more processors individually or collectively, cause the wireless audio device to measure a magnitude of the ambient audio signal obtained through the one or more microphones, determine a score indicating a degree to which the ambient audio signal corresponds to a dangerous audio signal using a dangerous audio signal detection model, and increase an output volume of the ambient audio signal based on the measured magnitude of the ambient audio signal and the determined score.

### CROSS-REFERENCE TO RELATED APPLICATION(S)

This application is a continuation application, claiming priority under 35 U.S.C. § 365(c), of an International application No. PCT/KR2025/004616, filed on Apr. 4, 2025, which is based on and claims the benefit of a Korean patent application number 10-2024-0084811, filed on Jun. 27, 2024, in the Korean Intellectual Property Office, and of a Korean patent application number 10-2024-0090563, filed on Jul. 9, 2024, in the Korean Intellectual Property Office, and of a Korean patent application number 10-2024-0097244, filed on Jul. 23, 2024, in the Korean Intellectual Property Office, the disclosure of each of which is incorporated by reference herein in its entirety.

### BACKGROUND

### 1. Field

The disclosure relates to a wireless audio device and an operating method thereof.

### 2. Description of Related Art

A wireless audio device may be connected wirelessly to an electronic device, such as a mobile phone and output audio data received from the mobile phone. The wireless audio device may provide a user with an ambient sound mode (transparency mode) and an active noise cancelling (ANC) mode. The ambient sound mode is a mode that makes the user hear external sounds. The ANC mode is a mode that blocks noise outside the wireless audio device.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wireless audio device and an operating method thereof.

Additional aspects will be set forth in part in the description which follows and, in part, will be apparent from the description, or may be learned by practice of the presented embodiments.

In accordance with an aspect of the disclosure, a wireless audio device including two or more earpieces is provided. Each of the earpieces includes one or more microphones configured to obtain an ambient audio signal from outside of the wireless audio, a speaker configured to output at least one of the obtained ambient audio signal or an audio content, and memory storing one or more computer programs, and one or more processors communicatively coupled to the one or more microphones, the speaker, and the memory, wherein the one or more computer programs include computer-executable instructions that, when executed by the one or more processors of the wireless audio device individually or collectively, cause the wireless audio device to measure a magnitude of the ambient audio signal obtained through the one or more microphones, determine a score indicating a degree to which the ambient audio signal corresponds to a dangerous audio signal using a dangerous audio signal detection model, and increase an output volume of the ambient audio signal based on the measured magnitude of the ambient audio signal and the determined score.

In accordance with another aspect of the disclosure, a method of operating a wireless audio device is provided. The method includes measuring a magnitude of an ambient audio signal obtained through one or more microphones, determining a score indicating a degree to which the ambient audio signal corresponds to a dangerous audio signal using a dangerous audio signal detection model, and increasing an output volume of the ambient audio signal based on the measured magnitude of the ambient audio signal and the determined score.

In accordance with another aspect of the disclosure, one or more non-transitory computer-readable storage media storing one or more computer programs including computer-executable instructions that, when executed by one or more processors of a wireless audio device individually or collectively, cause the wireless audio device to perform operations are provided. The operations include measuring a magnitude of an ambient audio signal obtained through one or more microphones, determining a score indicating a degree to which the ambient audio signal corresponds to a dangerous audio signal using a dangerous audio signal detection model, and increasing an output volume of the ambient audio signal based on the measured magnitude of the ambient audio signal and the determined score.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a wireless audio device and an electronic device according to an embodiment of the disclosure;

FIG. 2 is a diagram illustrating a communication environment of a wireless audio device and an electronic device according to an embodiment of the disclosure;

FIG. 3 is a diagram illustrating a front view and a rear view of a wireless audio device according to an embodiment of the disclosure;

FIG. 4 is a diagram illustrating adjusting a playback volume of an audio content and an output volume of an ambient audio signal according to an embodiment of the disclosure;

FIG. 5 is a diagram illustrating determining a reference value by a reference value determination module according to an embodiment of the disclosure;

FIG. 6 is a diagram illustrating adjusting a playback volume of an audio content and an output volume of an ambient audio signal according to a reference value according to an embodiment of the disclosure;

FIG. 7 is a diagram illustrating adjusting a playback volume of an audio content and an output volume of an ambient audio signal according to a reference value according to an embodiment of the disclosure;

FIGS. 8A, 8B, and 8C are flowcharts illustrating operations of a method of operating an earpiece according to various embodiments of the disclosure; and

FIG. 9 is a flowchart illustrating operations of adjusting a playback volume of an audio content and/or an output volume of an ambient audio signal according to a reference value according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

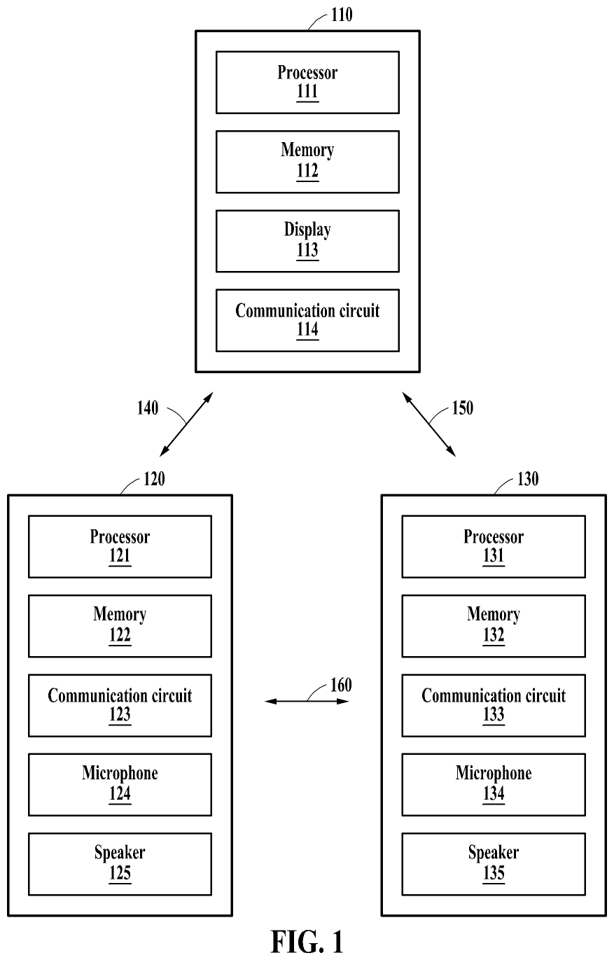

FIG. 1 is a block diagram illustrating a wireless audio device and an electronic device according to an embodiment of the disclosure.

Referring to FIG. 1, an electronic device 110 may include a processor 111, memory 112, a display 113, and/or a communication circuit 114.

The processor 111 may execute, for example, software, to control at least one other component (e.g., a hardware or software component) of the electronic device 110 connected to the processor 111 and may perform a variety of data processing or operations. According to an embodiment of the disclosure, as at least a part of data processing or computation, the processor 111 may store instructions or data received from another component (e.g., the communication circuit 114) in volatile memory, process the instructions or data stored in the volatile memory, and store result data in non-volatile memory. According to an embodiment of the disclosure, the processor 111 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently of or in conjunction with the main processor. For example, when the electronic device 110 includes the main processor and the auxiliary processor, the auxiliary processor may be adapted to consume less power than the main processor or to be specific to a specified function. The auxiliary processor may be implemented separately from the main processor or as a part of the main processor.

The auxiliary processor may control at least some of functions or states related to at least one (e.g., the display 113, a sensor module (not shown), or the communication circuit 114) of the components of the electronic device 110, instead of the main processor while the main processor is in an inactive (e.g., sleep) state or along with the main processor while the main processor is an active state (e.g., executing an application). According to an embodiment of the disclosure, the auxiliary processor (e.g., an ISP or a CP) may be implemented as a portion of another component (e.g., a camera module (not shown) or the communication circuit 114) that is functionally related to the auxiliary processor. According to an embodiment of the disclosure, the auxiliary processor (e.g., an NPU) may include a hardware structure specified for artificial intelligence (AI) model processing. An AI model may be generated through machine learning. Such learning may be performed by, for example, the electronic device 110 in which artificial intelligence is performed, or performed via a separate server. Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 112 may store one or more instructions that, when executed, cause the electronic device 110 or the processor 111 to perform various operations. The memory 112 may store a variety of data used by at least one component (e.g., the processor 111 or the communication circuit 114) of the electronic device 110. The variety of data may include, for example, software and input data or output data for instructions related thereto. The memory 112 may include, for example, volatile memory or non-volatile memory.

The display 113 may visually provide information to the outside (e.g., a user) of the electronic device 110. The display 113 may include, for example, a display, a hologram device, or a projector and control circuitry to control a corresponding one of the display, the hologram device, and the projector. According to an embodiment of the disclosure, the display 113 may include a touch sensor adapted to detect a touch, or a pressure sensor adapted to measure the intensity of force incurred by the touch. The display 113 may output an interface screen for controlling, for example, settings and/or operation modes of a first earpiece 120 and a second earpiece 130.

The communication circuit 114 may support establishing a direct (e.g., wired) communication channel or a wireless communication channel between the electronic device 110 and an external electronic device (e.g., the first earpiece 120 and/or the second earpiece 130) and performing communication via the established communication channel. The communication circuit 114 may include one or more CPs that operate independently of the processor 111 (e.g., an AP) and support direct (e.g., wired) communication or wireless communication. According to an embodiment of the disclosure, the communication circuit 114 may include a wireless communication module (e.g., a cellular communication module, a short-range wireless communication module, or a global navigation satellite system (GNSS) communication module) or a wired communication module (e.g., a local area network (LAN) communication module, or a power line communication (PLC) module). A corresponding one of these communication modules may communicate with an external electronic device via a first network (e.g., a short-range communication network, such as Bluetooth™, wireless-fidelity (Wi-Fi) direct, or infrared data association (IrDA)) or a second network (e.g., a long-range communication network, such as a legacy cellular network, a fifth-generation (5G) network, a next-generation communication network, the Internet, or a computer network (e.g., a LAN or a wide area network (WAN))). These various types of communication modules may be implemented as a single component (e.g., a single chip), or may be implemented as multi components (e.g., multiple chips) separate from each other. The wireless communication module may identify and authenticate the electronic device 110 in a communication network, such as the first network or the second network, using subscriber information (e.g., international mobile subscriber identity (IMSI)) stored in a subscriber identify module (SIM).

The wireless communication module may support a 5G network after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module may support a high-frequency band (e.g., a millimeter wave (mmWave) band) to achieve, e.g., a high data transmission rate. The wireless communication module may support various technologies for securing performance on a high-frequency band, such as, e.g., beamforming, massive multiple-input and multiple-output (massive MIMO), full dimensional MIMO (FD-MIMO), an array antenna, analog beamforming, or a large scale antenna. The wireless communication module may support various requirements specified in the electronic device 110, the external electronic device, or a network system. According to an embodiment of the disclosure, the wireless communication module may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

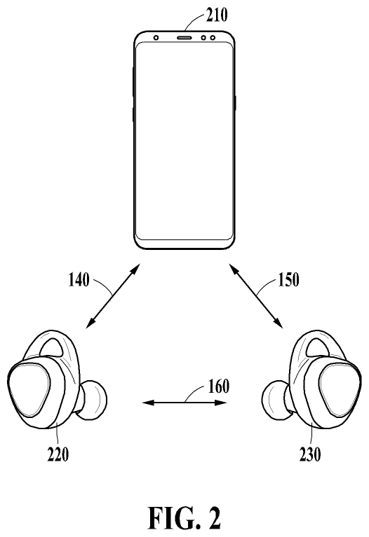

According to an embodiment of the disclosure, the electronic device 110 may be connected to the first earpiece 120 and/or the second earpiece 130 of a wireless audio device. The electronic device 110 may be connected to the first earpiece 120 through a first link 140, and the electronic device 110 and the first earpiece 120 may communicate in units of time slots set based on a clock of a primary device of the first link 140. The electronic device 110 may be connected to the second earpiece 130 via a second link 150. For example, the electronic device 110 may establish the second link 150 after being connected to the first earpiece 120. In an embodiment of the disclosure, the second link 150 may be omitted. The first earpiece 120 may be connected to the second earpiece 130 through a third link 160. The first link 140, the second link 150, and the third link 160 may be communication connections based on, for example, Bluetooth communication, but the scope of the embodiment is not limited thereto. A communication environment between the electronic device 110 and the first earpiece 120 and/or the second earpiece 130 will be described in more detail with reference to FIG. 2.

According to an embodiment of the disclosure, the first earpiece 120 may include a processor 121, memory 122, a communication circuit 123, a microphone 124, and a speaker 125.

The processor 121 may execute, for example, software, to control at least one other component (e.g., a hardware or software component) of the first earpiece 120 connected to the processor 121 and may perform a variety of data processing or operations. According to an embodiment of the disclosure, as at least a part of data processing or computation, the processor 121 may store instructions or data received from another component (e.g., the communication circuit 123) in volatile memory, process the instructions or data stored in the volatile memory, and store result data in non-volatile memory. According to an embodiment of the disclosure, the processor 121 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently of or in conjunction with the main processor.

In an embodiment of the disclosure, the processor 121 may include one or more processors, and the operations of the first earpiece 120 described in the disclosure may be performed by one processor or by a combination of multiple processors.

The processor 121 may obtain ambient audio data of the first earpiece 120 using one or more microphones 124. The ambient audio data of the first earpiece 120 may be audio data input to the one or more microphones 124 of the first earpiece 120. For example, when a user listens to an audio content transmitted from the electronic device 110 while wearing the first earpiece 120, the ambient audio data may include sounds from outside regardless of the audio content.

In an embodiment of the disclosure, the processor 121 may dynamically select or determine at least one microphone to obtain the ambient audio data among the plurality of microphones 124. The processor 121 may obtain the ambient audio data using the plurality of microphones 124. The plurality of microphones 124 may be microphones 124 to which a beamforming technology is applied. The processor 121 may be configured to perform processing (e.g., noise suppression, noise cancellation, or echo removal) on the obtained ambient audio signal.

According to an embodiment of the disclosure, the processor 121 may determine a score indicating a degree to which the ambient audio signal corresponds to a dangerous audio signal using a dangerous audio signal detection model. The processor 121 may increase an output volume of the ambient audio signal based on a magnitude of the ambient audio signal and the determined score. For example, the processor 121 may determine a reference value for volume adjustment using the measured magnitude of the ambient audio signal and the determined score, and may increase a playback volume of the audio content played back from the first earpiece 120 and/or the second earpiece 130 or reduce the output volume of the ambient audio signal based on the determined reference value.

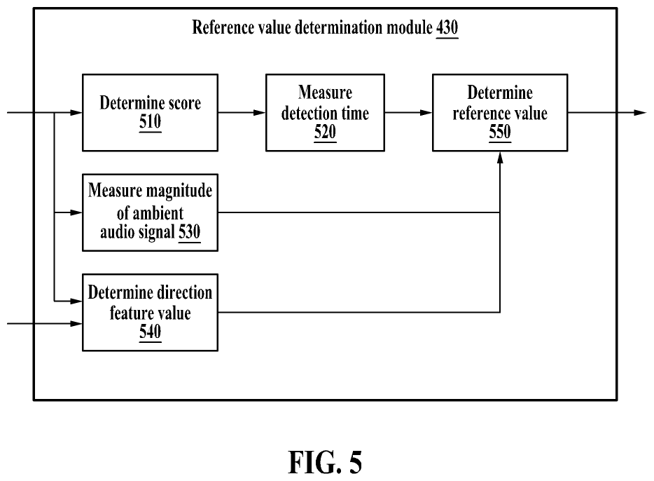

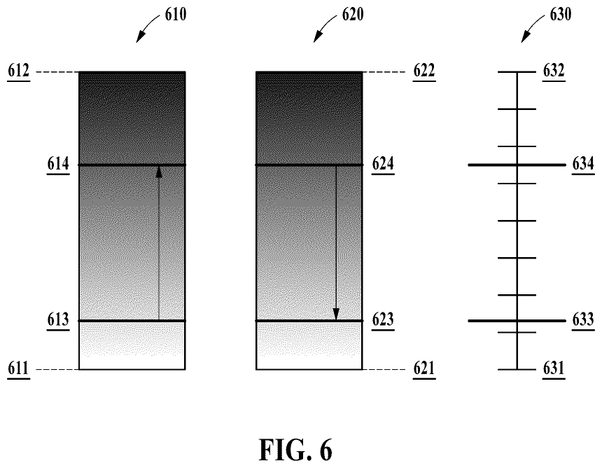

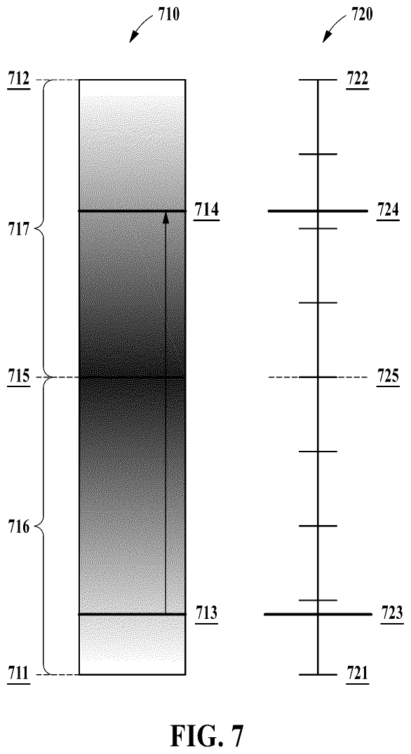

A process of determining the reference value will be described in more detail with reference to FIG. 5, and a process of adjusting at least one of the playback volume of the audio content and the output volume of the ambient audio signal will be described in more detail with reference to FIGS. 6 and 7.

The speaker 125 may output an acoustic signal to the outside of the first earpiece 120. For example, the speaker 125 may output the audio content received from the electronic device 110 and/or the ambient audio signal obtained through the microphone 124.

The communication circuit 123 may support establishing a direct (e.g., wired) communication channel or a wireless communication channel between the first earpiece 120 and an external electronic device (e.g., the electronic device 110 and/or the second earpiece 130) and performing communication via the established communication channel. The communication circuit 123 may include one or more CPs that operate independently of the processor 121 (e.g., an AP) and support direct (e.g., wired) communication or wireless communication. According to an embodiment of the disclosure, the communication circuit 123 may include a wireless communication module (e.g., a Bluetooth communication module).

The microphone 124 may include one or more microphones. The microphone 124 may be configured to detect an audio signal. For example, the microphone 124 may obtain an ambient audio signal transmitted from the outside of the first earpiece 120 to the first earpiece 120.

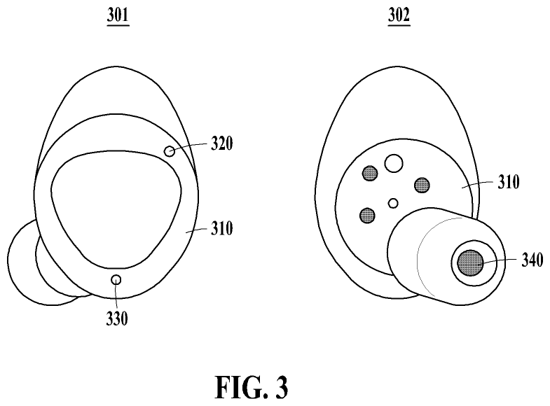

In an embodiment of the disclosure, when the first earpiece 120 includes the plurality of microphones 124, the plurality of microphones may correspond to different audio receiving paths, respectively. For example, when the microphone 124 includes a first microphone (e.g., a first microphone 320 of FIG. 3) and a second microphone (e.g., a second microphone 330 of FIG. 3), an ambient audio signal obtained by the first microphone and an ambient audio signal obtained by the second microphone may be treated as ambient audio signals obtained from different audio channels.

The memory 122 may store one or more instructions that, when executed, cause the processor 121 to perform various operations of the first earpiece 120. The memory 122 may store a variety of data used by at least one component (e.g., the processor 121) of the first earpiece 120. The variety of data may include, for example, software and input data or output data for instructions related thereto. The memory 122 may include, for example, volatile memory or non-volatile memory.

A second earpiece 130 according to an embodiment may include a processor 131, memory 132, a communication circuit 133, a microphone 134, and a speaker 135. The processor 131, the memory 132, the communication circuit 133, the microphone 134, and the speaker 135 of the second earpiece 130 may perform the same functions and/or operations as the processor 121, the memory 122, the communication circuit 123, the microphone 124, and the speaker 125 of the first earpiece 120, respectively. A repeated description thereof is omitted.

In an embodiment of the disclosure, the first earpiece 120 and the second earpiece 130 may be, for example, a set of wireless earphones worn on both ears of a user. In this case, the first earpiece 120 may correspond to a wireless earphone worn on the user's left ear, and the second earpiece 130 may correspond to a wireless earphone worn on the user's right ear.

In an embodiment of the disclosure, the first earpiece 120 and the second earpiece 130 may be, for example, a wireless headset worn on both ears of the user. In this case, the first earpiece 120 may correspond to a wireless headset part worn on the user's left ear, and the second earpiece 130 may correspond to a wireless headset part worn on the user's right ear.

When the electronic device 110 according to an embodiment and the first earpiece 120 and/or the second earpiece 130 are connected via a link (e.g., the first link 140 and/or the second link 150), the electronic device 110 may display one or more user interfaces (UIs) for controlling an operation mode of the first earpiece 120 and/or the second earpiece 130 through the display 113. The UI may include at least one of an interface for an ambient sound mode, an interface for an active noise cancellation (ANC) mode, and an interface for a variable ambient sound mode. The ambient sound mode (or an ambient aware mode) according to an embodiment is a mode in which external audio signals of the first earpiece and/or the second earpiece are transmitted to the user through the microphone. The term, ambient sound mode, may be replaced with an ambient aware mode or a transparency mode, but is not limited thereto. The ANC mode according to an embodiment is a mode that blocks external audio signals of the first earpiece and/or the second earpiece. The term ANC mode may be replaced with a noise cancellation mode or an ambient sound control mode, but is not limited thereto. A variable ambient sound mode according to an embodiment is a mode that adjusts the output volume of the external audio signal and/or the playback volume of the audio content depending on the external environment of the first earpiece and/or the second earpiece. The variable ambient sound mode may be provided based on the mixed use of the ambient sound mode and the ANC mode. The term, variable ambient sound mode may be replaced with a variable ambient aware mode or a variable noise control mode, but is not limited thereto.

The user may control an ambient noise level of the user by selecting one of an ambient sound mode interface, an ANC mode interface, and a variable ambient sound mode interface provided by the electronic device 110 according to the noise of a surrounding environment of the user.

FIG. 2 is a diagram illustrating a communication environment of a wireless audio device and an electronic device according to an embodiment of the disclosure.

Referring to FIG. 2, a first earpiece 220 may correspond to the first earpiece 120 of FIG. 1, and a second earpiece 230 may correspond to the second earpiece 130 of FIG. 1. An electronic device 210 may correspond to the electronic device 110 of FIG. 1. The electronic device 210 may include a user terminal, such as, for example, a smartphone, a tablet, a desktop computer, or a laptop computer. The first earpiece 220 and the second earpiece 230 may correspond to, but are not limited to, wireless earphones, wireless headsets, earbuds, or speaker systems. For example, the first earpiece 220 and the second earpiece 230 may correspond to various types of devices (e.g., hearing aids or portable audio devices) which receive audio signals and output the received audio signals.

The electronic device 210 and the first earpiece 220 and/or the second earpiece 230 may perform wireless communication at a short distance according to a Bluetooth network. The Bluetooth network may include, for example, a Bluetooth legacy network or a Bluetooth low energy (BLE) network.

According to an embodiment of the disclosure, the electronic device 210 may perform a function of a primary device (e.g., a master device), and the first earpiece 220 and/or the second earpiece 230 may perform a function of a secondary devices (e.g., a slave device). The number of devices for performing the function of the secondary device is not limited to the example shown in FIG. 2. According to an embodiment of the disclosure, the function of the primary device or the secondary device may be determined in an operation in which a link (e.g., 140, 150 and/or 160) between the devices is generated. According to another embodiment of the disclosure, one (e.g., the first earpiece 220) of the first earpiece 220 and the second earpiece 230 may perform a function of a primary device, and the other device (e.g., the second earpiece 230) may perform a function of a secondary device.

According to an embodiment of the disclosure, the electronic device 210 may transmit a data packet including an audio content to the first earpiece 220 and/or the second earpiece 230. In addition to the electronic device 210, at least one of the first earpiece 220 and/or the second earpiece 230 may also transmit a data packet to the electronic device 210. For example, when the audio content (e.g., music) is played on the electronic device 210, the electronic device 210 may transmit a data packet including the audio content via a link (e.g., the first link 140 and/or the second link 150) generated with the first earpiece 220 and/or the second earpiece 230, and at least one of the first earpiece 220 and/or the second earpiece 230 may transmit a data packet including data about an ambient audio signal to the electronic device 210 via the generated link.

According to an embodiment of the disclosure, the electronic device 210 may create or establish a link with at least one of the first earpiece 220 and/or the second earpiece 230 to transmit a data packet. For example, the electronic device 210 may generate the first link 140 with the first earpiece 220 and/or the second link 150 with the second earpiece 230 based on a Bluetooth or BLE protocol. In an embodiment of the disclosure, the electronic device 210 may communicate with the first earpiece 220 via the first link 140. In this case, for example, the second earpiece 230 may be set to monitor the first link 140. The second earpiece 230 may receive data transmitted by the electronic device 210 via the first link 140 by monitoring the first link 140.

FIG. 3 is a diagram illustrating a front view and a rear view of a wireless audio device according to an embodiment of the disclosure.

Referring to FIG. 3, an example of an external structure of the first earpiece (e.g., the first earpiece 220 of FIG. 2) will be described. For the convenience of description, a duplicate description is omitted, but the second earpiece (e.g., the second earpiece 230 of FIG. 2) may also have an external structure substantially the same as or similar to that of the first earpiece. The external structure of the second earpiece may have a shape corresponding to, for example, the external structure of the first earpiece.

In an embodiment of the disclosure, a reference numeral 301 shows a front view of the first earpiece. The first earpiece may include a housing 310. The housing 310 may form at least a portion of an exterior of the first earpiece. The first earpiece may include a plurality of microphones 320 and 330 disposed on a first surface (e.g., a surface facing the outside of the ear when the first earpiece is worn) of the housing 310. A first microphone 320 and a second microphone 330 may correspond to the one or more microphones 124 described above with reference to FIG. 1. The first microphone 320 and the second microphone 330 may be positioned to detect sounds coming from directions toward the user when the first earpiece is worn on a body (e.g., ear) of the user. The first microphone 320 and the second microphone 330 may detect sounds outside the housing 310. For example, the first microphone 320 and the second microphone 330 may detect sounds generated around the first earpiece. The first microphone 320 may detect an ambient audio signal coming from a rear or backward direction (e.g., a direction of back of a head) of the user, and the second microphone 330 may detect an ambient audio signal coming from a front or forward direction (e.g., a direction of a face) of the user.

According to the operation mode of the first earpiece, sounds of the surrounding environment (the ambient audio signals) detected through the first microphone 320 and/or the second microphone 330 may be output by a speaker 340. In an embodiment of the disclosure, the first microphone 320 and the second microphone 330 may be sound-receiving microphones for noise cancellation (e.g., ANC) function of the first earpiece. In addition, the first microphone 320 and the second microphone 330 may be sound-receiving microphones for an ambient sound listening function (e.g., a transparency function or ambient aware function) of the first earpiece. The first microphone 320 and the second microphone 330 may include various types of microphones, including, for example, an electronic condenser microphone (ECM) and a micro-electromechanical system (MEMS) microphone.

According to an embodiment of the disclosure, a reference numeral 302 shows a rear view of the first earpiece. The speaker 340 may be disposed on a second surface (e.g., a surface facing the user when the first earpiece is worn) of the housing 310. The speaker 340 may correspond to the speaker 125 of FIG. 1. The speaker 340 may convert an electrical signal into an audio signal. The speaker 340 may output a sound to the outside of the first earpiece (e.g., the user's ear). For example, the speaker 340 may convert an electrical signal into a sound that may be recognized audibly by the user and output the sound. At least a portion of the speaker 340 may be disposed inside the housing 310.

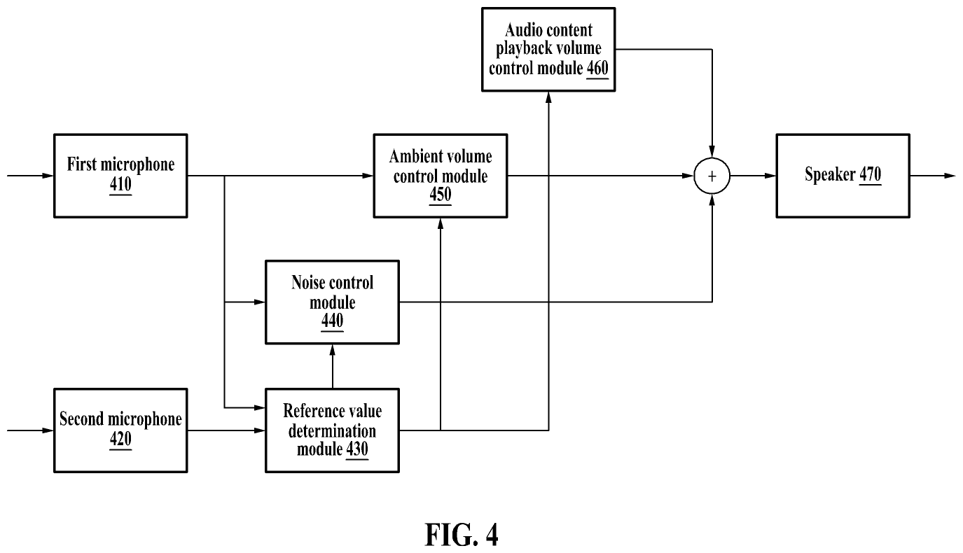

FIG. 4 is a diagram illustrating adjusting a playback volume of an audio content and an output volume of an ambient audio signal according to an embodiment of the disclosure.

Referring to FIG. 4, each of the earpieces (e.g., the first earpiece 120 and the second earpiece 130 of FIG. 1, and the first earpiece 220 and the second earpiece 230 of FIG. 2) included in the wireless audio device may increase the output volume of the ambient audio signal or reduce the playback volume of the audio content based on the measured magnitude of the ambient audio signal and the determined score. For example, each of the earpieces may determine a reference value using the measured magnitude of the ambient audio signal and the determined score, and adjust at least one of the playback volume of the audio content played on the wireless audio device and the output volume of the ambient audio signal based on the determined reference value.

In an embodiment of the disclosure, each of the earpieces may include a first microphone 410, a second microphone 420, a reference value determination module 430, a noise control module 440, an ambient volume control module 450, an audio content playback volume control module 460, and a speaker 470. The operations of the reference value determination module 430, the noise control module 440, the ambient volume control module 450, and the audio content playback volume control module 460 may be performed/controlled by the processor 121 of the first earpiece 120 and/or the processor 131 of the second earpiece 130 described above with reference to FIG. 1.

The first microphone 410 may obtain an ambient audio signal. The first microphone 410 may correspond to the first microphone 320 of FIG. 3. The ambient audio signal represents an audio signal transmitted from the outside of the wireless audio device. The ambient audio signal obtained through the first microphone 410 may be transmitted to the ambient volume control module 450, the noise control module 440, and the reference value determination module 430.

The second microphone 420 may obtain an ambient audio signal. The second microphone 420 may correspond to the second microphone 330 of FIG. 3. The ambient audio signal obtained through the second microphone 420 may be transmitted to the reference value determination module 430.

The reference value determination module 430 may determine a reference value based on the ambient audio signal transmitted from the first microphone 410 and the ambient audio signal transmitted from the second microphone 420. The reference value determination module 430 may determine the reference value based on a magnitude of the ambient audio signal, a score indicating a degree to which the ambient audio signal corresponds to a dangerous audio signal, and a detection time of the ambient audio signal. The process of determining the reference value by the reference value determination module 430 will be described in more detail with reference to FIG. 5.

An audio content refers to a content including audio data obtained from an electronic device, and a playback volume of the audio content may be adjusted through volume adjustment by the audio content playback volume control module 460 of the earpiece or volume adjustment by control of an electronic device (e.g., the electronic device 110 of FIG. 1). For example, the playback volume of the audio content may be reduced based on the measured magnitude of the ambient audio signal and the determined score in the earpiece. The audio content playback volume control module 460 may adjust the playback volume of the audio content played on the wireless audio device based on the reference value. For example, the audio content playback volume control module 460 may reduce the playback volume of the audio content played on the wireless audio device based on a gain for the playback volume of the audio content and a gain corresponding to the determined reference value.

According to an embodiment of the disclosure, the playback volume of the audio content and the output volume of the ambient audio signal may be adjusted by the control of an electronic device (e.g., the electronic device 110 of FIG. 1). For example, an earpiece (e.g., the first earpiece 120 of FIG. 1 and/or the second earpiece 130 of FIG. 1) may obtain an ambient audio signal and transmit the ambient audio signal to the electronic device. The electronic device may determine a score indicating a degree to which the transmitted ambient audio signal corresponds to a dangerous audio signal. The electronic device may measure the detection time of the ambient audio signal when the score is greater than or equal to a score threshold value, or greater than a first threshold value and less than or equal to a second threshold value. The electronic device may measure the magnitude of the ambient audio signal in parallel with the determining of the score. The electronic device may optionally determine a direction feature value for the ambient audio signal. The electronic device may determine a reference value for adjusting the playback volume of the audio content and the output volume of the ambient audio signal based on the determined magnitude of the ambient audio signal, the score indicating a degree to which the ambient audio signal corresponds to a dangerous audio signal, and the determined direction feature value. When the audio content is not being played, the electronic device may transmit a control signal to each of the earpieces to adjust the output volume of the ambient audio signal to an output volume of the ambient audio signal corresponding to the determined reference value. When the audio content is being played, the electronic device may transmit a control signal to each of the earpieces to adjust the output volume of the ambient audio signal and the playback volume of the audio content to an output volume of the ambient audio signal and a playback volume of the audio content corresponding to the determined reference value.

The ambient volume control module 450 may adjust the output volume of the ambient audio signal. The ambient volume control module 450 may adjust the output volume of the ambient audio signal obtained through the microphone using the measured magnitude of the ambient audio signal and the determined score. For example, the ambient volume control module 450 may reduce the output volume of the ambient audio signal by reducing a gain for the output volume of the ambient audio signal to a gain determined based on the measured magnitude of the ambient audio signal and the determined score.

The noise control module 440 may control the noise through ANC. The noise control module 440 may control the noise so that the output volume of the ambient audio signal increases. For example, the noise control module 440 may generate an anti-phase audio signal having an anti-phase with respect to the ambient audio signal, and increase the output volume of the ambient audio signal by reducing a gain of the anti-phase audio signal. The noise may be controlled.

The speaker 470 may output the audio content and the ambient audio signal with the volume adjusted based on the reference value.

In addition to the ambient aware mode in which an external sound of the wireless audio device input through a microphone is transmitted to a user through a speaker and the ANC mode in which an external sound of the wireless audio device is blocked, the wireless audio device may mix the ambient aware mode and the ANC mode to provide an adaptive ambient sound mode that adjusts a degree of blocking of an external sound of the wireless audio device based on changes in noise in a surrounding environment of the user. The wireless audio device may naturally notify a dangerous audio signal around the user through the adaptive ambient sound mode without disturbing the user.

When the user wears the wireless audio device and listens to the audio content, there is a risk that the user may not clearly recognize dangerous sounds (e.g., a car horn) generated around the user in addition to the audio content because the wireless audio device seals up the ear canal of the user. The wireless audio device according to an embodiment may adjust at least one of the playback volume of the audio content and the output volume of the ambient audio signal based on the reference value to allow the user to recognize that a dangerous audio signal has been generated from the outside so that the user may prepare for danger.

FIG. 5 is a diagram illustrating determining a reference value by a reference value determination module according to an embodiment of the disclosure.

The wireless audio device may adjust the output volume of the ambient audio signal (e.g., increase the output volume of the ambient audio signal) or adjust the playback volume of the audio content being played (e.g., decrease the volume of the audio content) based on the measured magnitude of the ambient audio signal, the determined score, the detection time during which the ambient audio signal corresponding to the score is detected, and/or the direction feature value for the ambient audio signal. For example, the wireless audio device may determine a reference value using the magnitude of the ambient audio signal, the determined score, the detection time, and/or the direction feature value, and adjust at least one of the playback volume of the audio content or the output volume of the ambient audio signal based on the determined reference value. The reference value may be determined by the reference value determination module 430.

Referring to FIG. 5, the reference value determination module 430 may perform operation 550 of determining a reference value based on an ambient audio signal obtained through a microphone (e.g., the first microphone 320 or the second microphone 330 of FIG. 3). The reference value indicates a value used as a reference to adjust a volume of a sound played or output from a wireless audio device (e.g., the first earpiece 120 or the second earpiece 130 of FIG. 1). For example, the reference value may represent a value determined based on an ambient audio signal to adjust at least one of a playback volume of an audio content being played on the wireless audio device and an output volume of an ambient audio signal. The term “reference value” may be replaced with the term “danger level”.

According to an embodiment of the disclosure, the reference value determination module 430 may determine the reference value based on a magnitude of the ambient audio signal and a score for the ambient audio signal. For example, the reference value determination module may measure a magnitude of an ambient audio signal obtained through a first microphone (e.g., the first microphone 320 of FIG. 3), determine a score for the ambient audio signal, and then determine a reference value using the measured magnitude of the ambient audio signal and the determined score.

The reference value determination module 430 according to an embodiment may determine the reference value based on the magnitude of the ambient audio signal, the score for the ambient audio signal, and a detection time during which the ambient audio signal is measured. For example, the reference value determination module 430 may measure the magnitude of the ambient audio signal obtained through the first microphone (e.g., the first microphone 320 of FIG. 3) and determine the score for the ambient audio signal. The reference value determination module 430 may measure the detection time for the ambient audio signal when the determined score is greater than a first threshold value and less than or equal to a second threshold value. The reference value determination module 430 may determine the reference value using the measured magnitude of the ambient audio signal, the determined score of the ambient audio signal, and the measured detection time.

The reference value determination module 430 according to an embodiment may determine the reference value based on the magnitude of the ambient audio signal, the score for the ambient audio signal, and a direction feature value for the ambient audio signal. For example, the reference value determination module 430 may measure the magnitude of the ambient audio signal obtained through the first microphone (e.g., the first microphone 320 of FIG. 3) and determine the score for the ambient audio signal. The reference value determination module 430 may determine the direction feature value for the ambient audio signal based on an ambient audio signal obtained through the first microphone and an ambient audio signal obtained through the second microphone. The reference value determination module 430 may determine the reference value using the measured magnitude of the ambient audio signal, the determined score of the ambient audio signal, and the determined direction feature value.

The reference value determination module 430 according to an embodiment may determine the reference value based on the magnitude of the ambient audio signal, the score for the ambient audio signal, the detection time during which the ambient audio signal is measured, and the direction feature value for the ambient audio signal. The magnitude of the ambient audio signal may be measured from the magnitude of the ambient audio signal obtained through the first microphone (e.g., the first microphone 320 of FIG. 3), and the score for the ambient audio signal and the detection time during which the ambient audio signal is measured may be determined based on the ambient audio signal obtained through the first microphone. The direction feature value for the ambient audio signal may be determined based on the ambient audio signal obtained through the second microphone (e.g., the second microphone 330 of FIG. 3).

In operation 510, the reference value determination module 430 may determine a score indicating a probability value that the ambient audio signal corresponds to a dangerous audio signal.

The score indicates a degree to which the ambient audio signal corresponds to a dangerous audio signal. The score may be determined as an output value of a neural network that has input an ambient audio signal as an input. The reference value determination module 430 may input the ambient audio signal into a dangerous audio signal detection model and obtain an output value output by the dangerous audio signal detection model. The dangerous audio signal detection model according to an embodiment may be based on a neural network model. The dangerous audio signal detection model may be a neural network model trained to output a probability value that the input data corresponds to a dangerous audio signal. The dangerous audio signal detection model may include a softmax layer that outputs a probability value that the input data corresponds to a dangerous audio signal. In an embodiment of the disclosure, the reference value determination module 430 may determine an output value of the softmax layer for the ambient audio signal as a score. The dangerous audio signal detection model according to an embodiment may be a model trained to output a probability value that the input data corresponds to a dangerous audio signal using a training audio signal. For example, the dangerous audio signal detection model may be trained using a training audio signal including car horn sound data, vehicle driving sounds, thunder sounds, explosion sounds, ambulance siren sound data, and/or human conversation sound data.

The reference value determination module 430 may determine whether an ambient audio signal obtained through a microphone is a dangerous audio signal based on the score. When the determined score is greater than or equal to a threshold score, the reference value determination module 430 may determine that the ambient audio signal is a dangerous audio signal. For example, when the determined score is greater than or equal to 0.5, the reference value determination module 430 may determine that the ambient audio signal is a dangerous audio signal, and when the score is less than 0.5, the reference value determination module 430 may determine that the ambient audio signal is not a dangerous audio signal. As the score is high, it is more likely that the ambient audio signal is a dangerous audio signal. Accordingly, the reference value determination module 430 may set the reference value to be higher as the determined score is high.

In operation 520, when the determined score is greater than a first threshold value and less than or equal to a second threshold value, the reference value determination module 430 may measure a signal detection time of the ambient audio signal. According to an embodiment of the disclosure, the first threshold value may be a value corresponding to 33% of the score percentage, and the second threshold value may be a value corresponding to 66% of the score percentage. For example, when the determined score is greater than a value corresponding to 33% of the score percentage and less than or equal to a value corresponding to 66% of the score percentage, the reference value determination module 430 may measure the signal detection time of the ambient audio signal. The ambient audio signal measured by the reference value determination module 430 may include both consecutive audio signals and discrete audio signals. The reference value determination module 430 may measure the signal detection time of the ambient audio signal within a maximum measurable detection time. The reference value determination module 430 may set the reference value to be larger as the measured detection time becomes longer.

In operation 530, the reference value determination module 430 may measure a magnitude of an ambient audio signal. The magnitude of the ambient audio signal represents a volume of the ambient audio signal obtained through a microphone (e.g., the first microphone 320 of FIG. 3). The reference value determination module 430 may temporarily or continuously measure the magnitude of the ambient audio signal. The reference value determination module 430 may set the reference value to be larger as the measured magnitude of the ambient audio signal is large within a maximum measurable magnitude limit of the audio signal.

A direction feature value represents a proportion of the magnitude of the ambient audio signal obtained in a specific direction in a sum of the magnitudes of the ambient audio signals obtained in two or more different directions. For example, the direction feature value may be a proportion of a magnitude of an ambient audio signal obtained from the back of the user wearing the wireless audio device in a sum of a magnitude of an ambient audio signal obtained from the front of the user wearing the wireless audio device and a magnitude of an ambient audio signal obtained from the back of the user wearing the wireless audio device.

The direction feature value may be defined by Equation 1 or Equation 2 according to an embodiment.

$$\frac{back signal power}{back signal power + front signal power} \qquad Equation 1$$

$$\frac{front signal power}{back signal power + front signal power} \qquad Equation 2$$

In Equations 1 and 2, a back signal power may correspond to a magnitude of an ambient audio signal obtained in a first direction, and a back signal power may correspond to a magnitude of an ambient audio signal obtained in a second direction.

In operation 540, the reference value determination module 430 may optionally determine a direction feature value for the ambient audio signal. The direction feature value may represent a direction from which the ambient audio signal is coming or a direction to a sound source in which the ambient audio signal is generated. The reference value determination module 430 may obtain an ambient audio signal in the first direction through a first microphone (e.g., the first microphone 320 of FIG. 3) and obtain an ambient audio signal in the second direction through a second microphone (e.g., the second microphone 330 of FIG. 3). The first microphone and the second microphone may be beamforming microphones. The first microphone may be directed to the front of the user wearing the wireless audio device, and the second microphone may be directed to the back of the user wearing the wireless audio device. The reference value determination module 430 may determine the direction feature value based on the magnitude of the ambient audio signal obtained by the first microphone and the second microphone.

As defined by Equations 1 and 2, the reference value determination module 430 may determine, as the direction feature value, a proportion of the magnitude of the ambient audio signal obtained in the first direction in a sum of the magnitude of the ambient audio signal obtained in the first direction and the magnitude of the ambient audio signal obtained in the second direction.

The reference value determination module 430 according to an embodiment may determine the reference value differently based on the direction of the ambient audio signal. For example, the reference value determination module 430 may determine a larger direction feature value when the obtained ambient audio signal is generated at the back of the user wearing wireless audio device, compared to a case of the ambient audio signal generated in front of the user.

In an embodiment of the disclosure, the first earpiece and/or the second earpiece may determine a direction of an ambient audio signal (e.g., a dangerous audio signal) (or a direction from which the dangerous audio signal generated). The first earpiece and/or the second earpiece may adjust at least one of a playback volume of the audio content and/or an output volume of the ambient audio signal based on the determined direction of the ambient audio signal. For example, when the ambient audio signal is determined as a dangerous audio signal, the first earpiece and/or the second earpiece may increase an output volume of a dangerous audio device closer to the determined direction.

According to an embodiment of the disclosure, the first earpiece and/or the second earpiece may determine a direction for an external audio signal based on the determined direction feature value, a magnitude of an external audio signal measured by the first earpiece (e.g., the first earpiece 120 of FIG. 1), and a magnitude of an external audio signal measured by the second earpiece (e.g., the second earpiece 130 of FIG. 1).

According to an embodiment of the disclosure, when the direction feature value based on Equation 1 is greater than or equal to a threshold direction feature value, the reference value determination module may determine that the direction of the external audio signal (e.g., a dangerous audio signal) is the back of the user wearing the first earpiece. When the determined direction of the external audio signal is the back of the user, the first earpiece may reduce the playback volume of the audio content to a minimum volume and increase the output volume of the ambient audio signal to a maximum volume.

According to an embodiment of the disclosure, when the direction feature value based on Equation 1 is less than the threshold direction feature value, the first earpiece may determine that the direction of the external audio signal is in front of the user wearing the wireless audio device. When the determined direction of the wireless audio signal is the front of the user, the wireless audio device may maintain the playback volume of audio content and increase the output volume of the ambient audio signal. When the determined direction of the ambient audio signal is the front of the user, the first earpiece may make the ambient audio signal clearly audible by adjusting only the output volume of the ambient audio signal without disturbing the user listening to the audio content.

According to an embodiment of the disclosure, when a difference value between a magnitude of an external audio signal measured by a first earpiece (e.g., a right earpiece) and a magnitude of an external audio signal measured by a second earpiece (e.g., a left earpiece) is greater than or equal to a first threshold magnitude difference value, the first earpiece and the second earpiece may determine that the direction of the external audio signal is a right direction of the user wearing the wireless audio device. When the direction of the external audio signal is determined as the right direction, the second earpiece may maintain the output volume of the ambient audio signal and the playback volume of the audio content, and the first earpiece may maintain the playback volume of the audio content and increase the output volume of the ambient audio signal. When the determined direction of the external audio signal is the right direction, the first earpiece may clearly transfer the ambient audio signal coming from the right to the user by increasing only the output volume of the ambient audio signal output from the first earpiece.

According to an embodiment of the disclosure, when a magnitude difference value between a magnitude of the ambient audio signal measured by the first earpiece (e.g., a right earpiece) and a magnitude of the ambient audio signal measured by a second earpiece (e.g., a left earpiece) is less than or equal to a second threshold magnitude difference value, the first earpiece and the second earpiece may determine that the direction of the external audio signal is the left direction of the user wearing the wireless audio device. When the direction of the external audio signal is determined as the left direction, the first earpiece may maintain the output volume of the ambient audio signal and the playback volume of the audio content, and the second earpiece may maintain the playback volume of the audio content and increase the output volume of the ambient audio signal. When the determined direction of the external audio signal is the left direction, the second earpiece may clearly transfer the ambient audio signal coming from the left to the user by increasing only the output volume of the ambient audio signal output from the second earpiece.

Operations 510, 520, 530, and 540 may be performed in parallel or sequentially.

In operation 550, the reference value determination module 430 may determine the reference value based on all or some of the measured magnitude of the ambient audio signal, the determined score, the measured detection time, and the determined direction feature value. According to an embodiment of the disclosure, the reference value determination module 430 may determine the reference value based on the determined score, a ratio between the measured magnitude of the ambient audio signal and a set maximum magnitude, a ratio between the measured detection time and a set maximum detection time, and the direction feature value of the ambient audio signal. Generally, a dangerous audio signal that alerts danger may be a loud sound and a relatively long audio signal. Therefore, the reference value that may indicate the degree of danger may be proportional to the magnitude of the ambient audio signal and proportional to duration of the ambient audio signal.

According to an embodiment of the disclosure, when the direction feature value is a proportion of the magnitude of the ambient audio signal obtained from the back (or front) of the user in a sum of the magnitude of the ambient audio signal obtained from the front of the user wearing the wireless audio device and the magnitude of the ambient audio signal obtained from the back of the user wearing the wireless audio device, the reference value determination module 430 may set the reference value to be larger as the determined direction feature value is larger (or smaller). It is generally difficult for the user wearing the wireless audio device to recognize a dangerous signal generated from the back of the user, and therefore, the reference value may be proportional to the direction feature value.

According to an embodiment of the disclosure, the reference value determination module 430 may determine, as a reference value, a percentage value of the sum of a score, a ratio between the measured magnitude of the ambient audio signal and the set maximum magnitude, and a ratio between the measured detection time and the set maximum detection time based on Equation 3 or Equation 4, and the reference value may be expressed as a value in a range of 0.0% to 100%. For example, the reference value determination module 430 may determine a percentage value of the sum of the score and the ratio between the measured magnitude of the ambient audio signal and the set maximum magnitude as the reference value according to Equation 3, and may optionally determine a percentage value of the sum of the score, the ratio between the measured magnitude of the ambient audio signal and the set maximum magnitude, and the ratio between the measured detection time and the set maximum detection time as the reference value according to Equation 4.

$$( soft max + \frac{loudness}{max loudness} ) \times 100 \qquad Equation 3$$

$$( soft max + \frac{time}{max time} + \frac{loudness}{max loudness} ) \times 100 \qquad Equation 4$$

In Equations 3 and 4, softmax represents a score, time/max time represents a ratio between a measured detection time and a set maximum detection time, and loudness/max loudness represents a ratio between a measured magnitude of an ambient audio signal and a magnitude of a maximum measurable ambient audio signal.

The reference value determination module 430 according to an embodiment may determine a percentage value of the product of a score, a ratio between the measured magnitude of the ambient audio signal and the set maximum magnitude, and a ratio between the measured detection time and the set maximum detection time as the reference value based on Equation 5 or Equation 6. For example, the reference value determination module 430 may determine a percentage value of the product of the score and the ratio between the measured magnitude of the ambient audio signal and the set maximum magnitude as the reference value according to Equation 5, and may optionally determine a percentage value of the product of the score, the ratio between the measured magnitude of the ambient audio signal and the set maximum magnitude, and the ratio between the measured detection time and the set maximum detection time as the reference value according to Equation 6.

$$soft max \times \frac{loudness}{max loudness} \times 100 \qquad Equation 5$$

$$soft max \times \frac{time}{max time} \times \frac{loudness}{max loudness} \times 100 \qquad Equation 6$$

In Equations 5 and 6, softmax represents a score, time/max time represents a ratio between a measured detection time and a set maximum detection time, and loudness/max loudness represents a ratio between a measured magnitude of an ambient audio signal and a magnitude of a maximum measurable ambient audio signal.

The reference value determination module 430 according to an embodiment may determine a percentage value of the product of a score, a ratio between the measured magnitude of the ambient audio signal and the set maximum magnitude, a ratio between the measured detection time and the set maximum detection time, and a direction feature value for the ambient audio signal as the reference value based on Equation 7 or Equation 8. For example, the reference value determination module 430 may determine a percentage value of the product of the score, the ratio between the measured magnitude of the ambient audio signal and the set maximum magnitude, and the direction feature value as the reference value according to Equation 7, and may optionally determine a percentage value of the product of the score, the ratio between the measured magnitude of the ambient audio signal and the set maximum magnitude, the ratio between the measured detection time and the set maximum detection time, and the direction feature value as the reference value according to Equation 8.

$$soft max \times \frac{loudness}{max loudness} \times BFratio \times 100 \qquad Equation 7$$

$$soft max \times \frac{time}{max time} \times \frac{loudness}{max loudness} \times BFratio \times 100 \qquad Equation 8$$

In Equations 7 and 8, softmax represents a score, time/max time represents a ratio between a measured detection time and a set maximum detection time, loudness/max loudness represents a ratio between a measured magnitude of an ambient audio signal and a magnitude of a maximum measurable ambient audio signal, and BF ratio represents a direction feature value for an ambient audio signal.

The reference value determination module 430 according to an embodiment may optimize the reference value by applying weights to the measured magnitude of the ambient audio signal, the determined score, the measured detection time, and the determined direction feature value. The weights for optimizing each of the determined score, the measured detection time, the measured magnitude of the ambient audio signal, and the determined direction feature value may be represented by w₁, w₂, w₃, and w₄.

$$( {w}_{1} \times soft max + {w}_{2} \times \frac{time}{max time} + {w}_{3} \times \frac{loudness}{max loudness} ) \times 100 \qquad Equation 9$$

$$( {w}_{1} \times soft max ) \times ( {w}_{3} \times \frac{loudness}{max loudness} ) \times 100 \qquad Equation 10$$

$$( {w}_{1} \times soft max ) \times ( {w}_{2} \times \frac{time}{max time} ) \times ( {w}_{3} \times \frac{loudness}{max loudness} ) \times 100 \qquad Equation 11$$

$$( {w}_{1} \times soft max ) \times ( {w}_{3} \times \frac{loudness}{max loudness} ) \times ( {w}_{4} \times BFratio ) \times 100 \qquad Equation 12$$

$$( {w}_{1} \times soft max ) \times ( {w}_{2} \times \frac{time}{max time} ) \times ( {w}_{3} \times \frac{loudness}{max loudness} ) \times ( {w}_{4} \times BFratio ) \times 100 \qquad Equation 13$$

Equations 9, 10, 11, 12, and 13 are equations in which the weights are applied to Equations 3, 4, 5, 6, 7, and 8.

Equation 9 may become Equation 3 when the weight w₁ is 1, the weight w₂ is 0, and the weight w₃ is 1, and Equation 9 may become Equation 4 when the weight w₁ is 1, the weight w₂ is 1, and the weight w₃ is 1. Equation 10 may become Equation 5 when the weight w₁ is 1 and the weight w₃ is 1. Equation 11 may become Equation 6 when the weight w₁ is 1, the weight w₂ is 1, and the weight w₃ is 1. Equation 12 may become Equation 7 when the weight w₁ is 1, the weight w₃ is 1, and the weight w₄ is 1, and Equation 13 may become Equation 8 when the weight w₁ is 1, the weight w₂ is 1, the weight w₃ is 1, and the weight w₄ is 1. The values of the weights w₁, w₂, w₃, and w₄ described above are examples and are not limited thereto. The weights w₁, w₂, w₃, and w₄ according to an embodiment may be defined as values greater than or equal to 0 and less than or equal to 1 to optimize the reference value determination module 430.

In Equations 9, 10, 11, 12, and 13, softmax represents a score, loudness/max loudness represents a ratio between a measured magnitude of an ambient audio signal and a magnitude of a maximum measurable ambient audio signal, time/max time represents a ratio between a measured detection time and a set maximum detection time, and BF ratio represents a direction feature value for an ambient audio signal.

FIG. 6 is a diagram illustrating adjusting a playback volume of an audio content and an output volume of an ambient audio signal according to a reference value according to an embodiment of the disclosure.

Referring to FIG. 6, the earpiece (e.g., the first earpiece 120 or the second earpiece 130 of FIG. 1) may simultaneously adjust the playback volume of the audio content and the output volume of the ambient audio signal based on the determined reference value. For example, the first earpiece may increase the output volume of the ambient audio signal and reduce the playback volume of the audio content based on the measured magnitude of the ambient audio signal and the determined score. The earpiece may determine the reference value based on Equations 3 to 13.

A reference numeral 610 represents a range of magnitudes that an output volume of an ambient audio signal may have. A reference numeral 611 represents a minimum value of an output volume of an ambient audio signal, and a reference numeral 612 represents a maximum value of an output volume of an ambient audio signal.

A reference numeral 620 represents a range of magnitudes that a playback volume of an audio content may have. A reference numeral 621 represents an initial value of a playback volume of an audio content, and a reference numeral 622 represents a maximum value of a playback volume of an audio content. A reference numeral 630 represents a range of reference values. A reference numeral 631 represents a minimum value of a reference value, and a reference numeral 632 represents a maximum value of a reference value. Reference numerals 633 and 634 represent reference values.

According to an embodiment of the disclosure, the earpiece may adjust the playback volume of the audio content and the output volume of the ambient audio signal by adjusting a gain for the playback volume of the audio content, a gain for the output volume of the ambient audio signal, and a gain for a signal that is opposite in phase to the noise based on the second reference value 634. When the reference value is the second reference value 634, the earpiece may reduce the playback volume of the audio content and increase the output volume of the ambient audio signal based on the gain for the playback volume of the audio content, the gain for the output volume of the ambient audio signal, and the gain for the signal that is opposite in phase to the noise corresponding to the second reference value 634. According to an embodiment of the disclosure, when the reference value is changed from the first reference value 633 to the second reference value 634, the earpiece may increase the output volume of the ambient audio signal from an output volume 613 of the ambient audio signal corresponding to the first reference value 633 to an output volume 614 of the ambient audio signal corresponding to the second reference value 634, and may reduce the playback volume of the audio content from a playback volume 624 of the audio content corresponding to the first reference value 633 to a playback volume 623 of the audio content corresponding to the second reference value 634. Through the above process, the output volume of the ambient audio signal may increase than a volume before being adjusted to a first target playback volume by adjusting the output volume to the first target playback volume, and the playback volume of the audio content may decrease than a volume before being adjusted to a second target playback volume by adjusting the playback volume to the second target playback volume.

The earpiece according to an embodiment may simultaneously adjust the playback volume of the audio content and the output volume of the ambient audio signal based on the reference value. The earpiece may adjust the playback volume of the audio content and the output volume of the ambient audio signal based on a gain for the playback volume of the audio content to fixed gain corresponding to the reference value, a gain for the output volume of the ambient audio signal and/or a gain for a signal that is opposite in phase to the noise. Alternatively, the earpiece may simultaneously adjust the playback volume of the audio content and the output volume of the ambient audio signal based on a gain for a playback volume of a current audio content for a current volume, a gain for an output volume of an ambient audio signal for a current volume, and/or a ratio of a signal that is opposite in phase to the noise for a current volume.

When the gain for the output volume of the ambient audio signal is greater than the gain for the output volume of the ambient audio signal corresponding to the determined reference value, the earpiece according to an embodiment may not adjust the output volume of the ambient audio signal. When the gain for the output volume of the ambient audio signal corresponding to the determined reference value is smaller than the gain for the output volume of the ambient audio signal, it is safer to maintain the output volume of the ambient audio signal, and therefore, the output volume of the ambient audio signal may not be adjusted.

FIG. 7 is a diagram illustrating adjusting a playback volume of an audio content and an output volume of an ambient audio signal according to a reference value according to an embodiment of the disclosure.

Referring to FIG. 7, the wireless audio device may adjust the output volume of the ambient audio signal and adjust the playback volume of the audio content based on the determined reference value. For example, when the determined reference value is less than a threshold reference value (e.g., a threshold reference value 725), the wireless audio device may increase only the volume of the ambient audio signal heard by the user, and when the determined reference value exceeds the threshold reference value (e.g., the threshold reference value 725), the wireless audio device may increase the volume of the ambient audio signal and reduce the playback volume of the audio content. When the determined reference value is a threshold reference value (e.g., the threshold reference value 725), the wireless audio device may increase the output volume of the ambient audio signal to a maximum volume and increase the playback volume of the audio content to a maximum volume.

A reference numeral 710 represents a range connecting a range 716 of magnitudes that the output volume of the ambient audio signal may have, a range 717 of magnitudes that the playback volume of the audio content may have. A reference numeral 711 represents a minimum value of the output volume of the ambient audio signal, a reference numeral 715 represents a maximum value of the output volume of the ambient audio signal (or a maximum value of the playback volume of the audio content), and a reference numeral 712 represents a minimum value of the playback volume of the audio content. A playback volume 714 of the audio content represents a playback volume of the audio content corresponding to a determined reference value 724, and a reference numeral 713 represents an output volume of the ambient audio signal corresponding to a third reference value 723.

A reference numeral 720 represents a range of magnitudes that the reference value may have. A reference numeral 721 represents a minimum value of the reference value, and a reference numeral 722 represents a maximum value of the reference value. Reference numerals 723 and 724 represent determined reference values, and a reference numeral 725 represents a threshold reference value 725 for the reference value.

When the reference value according to an embodiment is determined to be less than or equal to the threshold reference value 725, the wireless audio device according to an embodiment may increase the output volume of the ambient audio signal to the first target playback volume and maintain the playback volume of the audio content. The first target playback volume is a volume of the ambient audio signal corresponding to the reference value that is less than or equal to the threshold reference value 725.

According to an embodiment of the disclosure, the output volume of the ambient audio signal may be increased than a volume before being adjusted to the first target playback volume by adjusting the output volume to the first target playback volume. The first target playback volume corresponding to the reference value may be predefined. For example, the first target playback volume corresponding to the threshold reference value 725 may be defined as a volume corresponding to 100% of a volume of a currently input ambient audio signal, and when the reference value is changed from the third reference value 723 to the threshold reference value 725, the wireless audio device may increase a volume of the output ambient audio signal to a volume of an ambient audio signal input through a microphone.

When the determined reference value is greater than the threshold reference value 725, the wireless audio device according to an embodiment may increase the output volume of the ambient audio signal to a second target playback volume and reduce the playback volume of the audio content to a third target playback volume corresponding to the determined reference value 724. The third target playback volume is the playback volume 714 of the audio content corresponding to the determined reference value 724. The output volume of the ambient audio signal may correspond to the maximum value 715 of the ambient audio signal corresponding to the determined reference value 724. The second target playback volume may be the maximum value 715 of the ambient audio signal corresponding to the determined reference value 724. The output volume of the ambient audio signal may increase than a volume before being adjusted to the second target playback volume by adjusting the output volume to the second target playback volume, and the playback volume of the audio content may decrease than a volume before being adjusted to the third target playback volume by adjusting the playback volume to the third target playback volume. For example, when the reference value is changed from the third reference value 723 to the determined reference value 724, the output volume 713 of the ambient audio signal corresponding to the third reference value 723 may increase to the maximum value 715 of the ambient audio signal corresponding to the determined reference value 724, and the playback volume of the audio content may decrease to the playback volume 714 of the audio content corresponding to the determined reference value 724.

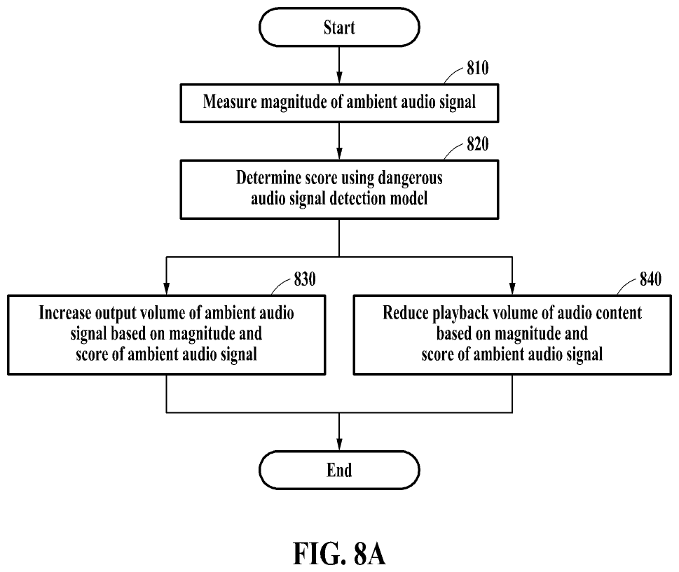

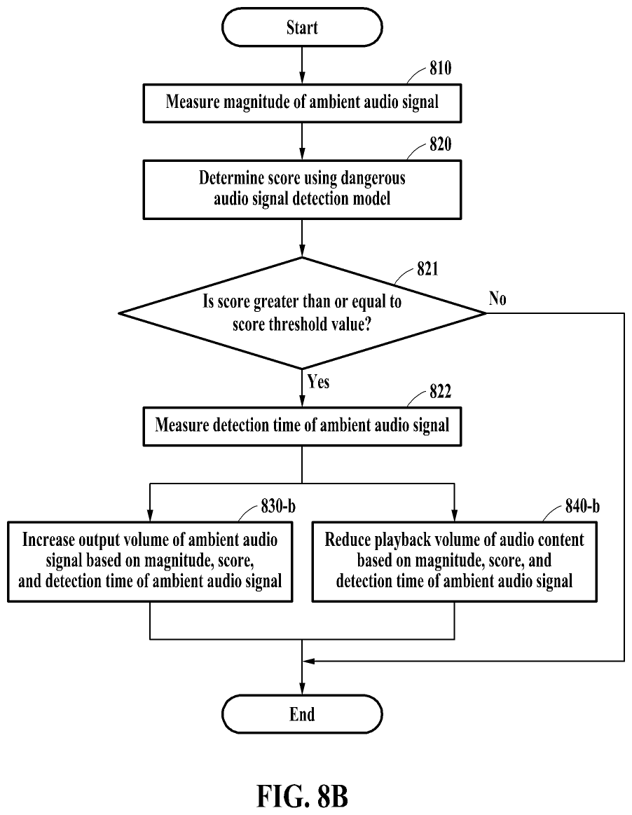

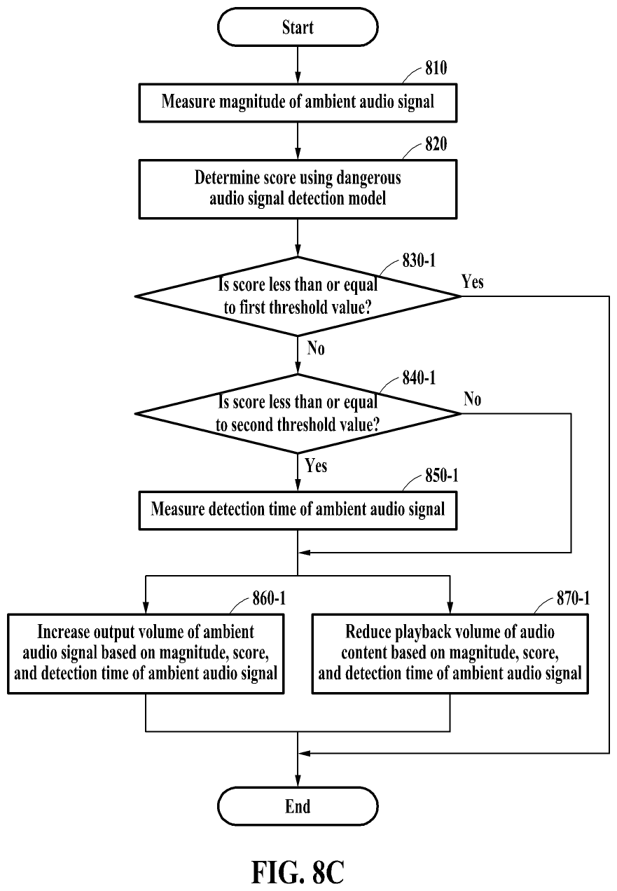

FIG. 8A is a flowchart illustrating operations of a method of operating an earpiece according to an embodiment of the disclosure.

Referring to FIG. 8A, in operation 810, an earpiece (e.g., the first earpiece 120 of FIG. 1) may measure a magnitude of an ambient audio signal. The earpiece may measure the magnitude of the ambient audio signal obtained through one or more microphones (e.g., the microphones 124 and 134 of FIG. 1).

In operation 820, the earpiece may determine a score using a dangerous audio signal detection model. In an embodiment of the disclosure, the dangerous audio signal detection model may include a softmax layer that outputs a probability value that input data corresponds to a dangerous audio signal. The earpiece may determine an output value of the softmax layer for the ambient audio signal as a score.

In operation 830, the earpiece may increase an output volume of the ambient audio signal based on the magnitude of the ambient audio signal and the score. For example, the earpiece may determine a reference value using the magnitude of the ambient audio signal and the score, and increase the output volume of the ambient audio signal based on the determined reference value.

In operation 840, the earpiece may reduce a playback volume of the audio content based on the magnitude of the ambient audio signal and the score. For example, the earpiece may determine a reference value using the magnitude of the ambient audio signal and the score, and reduce the playback volume of the audio content based on the determined reference value.

The earpiece according to an embodiment may perform the operation of reducing the playback volume of the audio content (operation 840) and the operation of increasing the output volume of the ambient audio signal (operation 830) in parallel. For example, the earpiece may determine a reference value using the score obtained in operation 820 and the magnitude of the ambient audio signal measured in operation 810, and increase the output volume of the ambient audio signal and reduce the playback volume of the audio content based on the determined reference value. When the determined reference value is a maximum value, the earpiece may reduce the playback volume of the audio content to a minimum volume and increase the output volume of the ambient audio signal to a maximum volume.

FIG. 8B is a flowchart illustrating operations of a method of operating an earpiece according to an embodiment of the disclosure.

Referring to FIG. 8B, operations 810 and 820 are the same as operations 810 and 820 of FIG. 8A, respectively, and thus any duplicate description will be omitted hereinafter.

When the score is less than a score threshold value (e.g., “No” in operation 821), the earpiece may stop adjusting the playback volume of the audio content and the output volume of the ambient audio signal. The score threshold value may be a value corresponding to 50% of the percentage of the score. According to an embodiment of the disclosure, when the score threshold value is a value corresponding to 50% of the percentage of the score and the determined score is less than the score threshold value, the earpiece may stop adjusting the playback volume of the audio content and the output volume of the ambient audio signal.

When the score is greater than or equal to the score threshold value (e.g., “Yes” in operation 821), in operation 822, the earpiece may measure a detection time of the ambient audio signal.

In operation 830-b, the earpiece may increase the output volume of the ambient audio signal based on the magnitude, the score, and the detection time of the ambient audio signal. For example, the earpiece may determine a reference value using the magnitude, the score, and the detection time of the ambient audio signal and increase the output volume of the ambient audio signal based on the determined reference value.

In operation 840-b, the earpiece may reduce the playback volume of the audio content based on the magnitude, the score, and the detection time of the ambient audio signal. For example, the earpiece may determine the reference value using the magnitude, the score, and the detection time of the ambient audio signal, and reduce the playback volume of the audio content based on the determined reference value.

The earpiece according to an embodiment may perform the operation of reducing the playback volume of the audio content (operation 840-b) and the operation of increasing the output volume of the ambient audio signal (operation 830-b) in parallel. The operations of the earpiece performing the operation of reducing the playback volume of the audio content by the earpiece and the operation of increasing the output volume of the ambient audio signal in parallel corresponds to operation 840 and operation 830 of FIG. 8A, and thus any duplicate description will be omitted hereinafter.

FIG. 8C is a flowchart illustrating operations of a method of operating an earpiece according to an embodiment of the disclosure.

Referring to FIG. 8C, operations 810 and 820 are the same as operations 810 and 820 of FIG. 8A, respectively, and thus any duplicate description will be omitted hereinafter.

When the determined score is less than or equal to a first threshold value (e.g., “Yes” in operation 830-1), the earpiece may stop adjusting the playback volume of the audio content and the output volume of the ambient audio signal. According to an embodiment of the disclosure, the first threshold value may be a value corresponding to 33% of the percentage of the score. When the determined score is less than or equal to the value corresponding to 33% of the percentage of the score, the earpiece may stop adjusting the playback volume of the audio content and the output volume of the ambient audio signal.

When the determined score is greater than the first threshold value (e.g., “No” in operation 830-1) and greater than a second threshold value (e.g., “No” in operation 840-1), the earpiece may increase the output volume of the ambient audio signal or reduce the playback volume of the audio content based on the magnitude and the score of the ambient audio signal without measuring the detection time according to operation 850-1. According to an embodiment of the disclosure, the second threshold value may be a value greater than the first threshold value, and the second threshold value may be a value corresponding to 66% of the percentage of the score. When the determined score is greater than the second threshold value (e.g., the value corresponding to 66% of the percentage of the score), the earpiece may determine a reference value using the magnitude and the score of the ambient audio signal. The earpiece may increase the output volume of the ambient audio signal and reduce the playback volume of the audio content based on the determined reference value. When the score is greater than the second threshold, there is a high possibility that the ambient audio signal is a dangerous audio signal. Therefore, the wireless audio device may adjust the playback volume of the audio content to a minimum volume and adjust the output volume of the ambient audio signal to a maximum volume to clearly notify the user of the dangerous audio signal.

When the determined score is greater than the first threshold value (e.g., “No” in operation 830-1) and less than or equal to the second threshold value (e.g., “Yes” in operation 840-1), in operation 850-1, the earpiece may measure the detection time of the ambient audio signal.

In operation 860-1, the earpiece may increase the output volume of the ambient audio signal based on the magnitude, the score, and the detection time of the ambient audio signal, and in operation 870-1, the earpiece may reduce the playback volume of the audio content based on the magnitude, the score, and the detection time of the ambient audio signal. Operations 860-1 and 870-1 correspond to operations 830-b and 840-b of FIG. 8B, respectively, and thus any duplicate description will be omitted hereinafter.

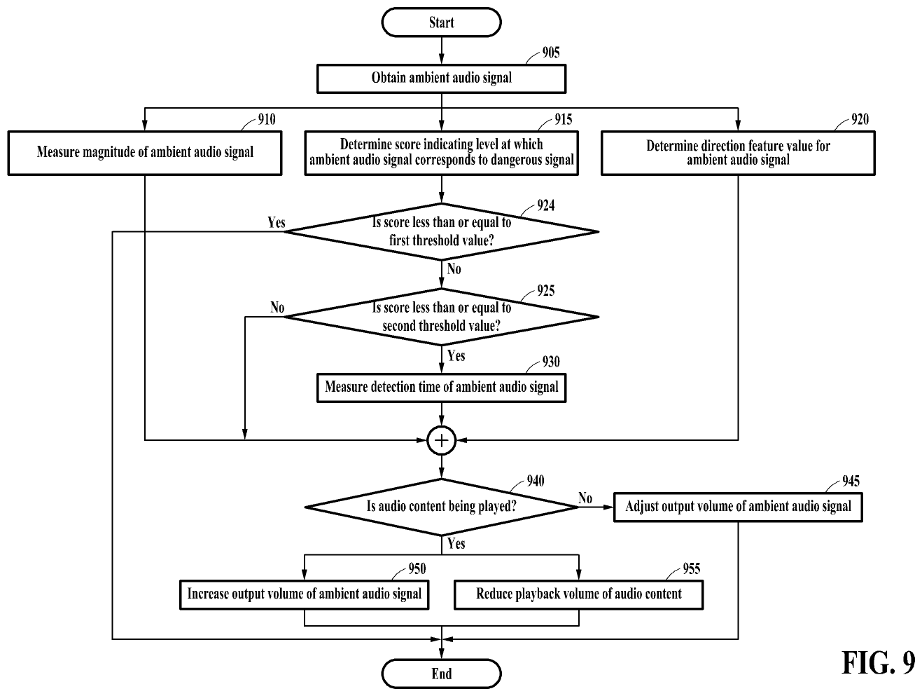

FIG. 9 is a flowchart illustrating operations of adjusting a playback volume of an audio content and/or an output volume of an ambient audio signal according to a reference value according to an embodiment of the disclosure. The operations of adjusting the playback volume of the audio content and the output volume of the ambient audio signal may be performed by the earpiece (e.g., the first earpiece 120 and/or the second earpiece 130 of FIG. 1).

Referring to FIG. 9, in operation 905, the earpiece may obtain an ambient audio signal. The earpiece may measure the ambient audio signal obtained through one or more microphones (e.g., the microphones 124 and 134 of FIG. 1).

In operation 910, the earpiece may measure a magnitude of the ambient audio signal. For example, the earpiece may measure the magnitude of an ambient audio signal obtained through a first microphone (e.g., the first microphone 320 of FIG. 3) and an ambient audio signal obtained through a second microphone (e.g., the second microphone 330 of FIG. 3).

In operation 920, the earpiece may determine a direction feature value for the ambient audio signal. The earpiece may optionally determine the direction feature value for the ambient audio signal. For example, the earpiece may not determine the direction feature value for the ambient audio signal, but may only determine the magnitude and a score of the ambient audio signal. Alternatively, the earpiece may determine the direction feature value and the score for the ambient audio signal and measure the magnitude of the ambient audio signal.

In operation 915, the earpiece may determine the score indicating a degree to which the ambient audio signal corresponds to a dangerous audio signal. The earpiece may determine the score using a dangerous audio signal detection model. When the score is less than or equal to a first threshold value (e.g., “Yes” in operation 924), the earpiece may stop adjusting the playback volume of the audio content and the output volume of the ambient audio signal. According to an embodiment of the disclosure, the first threshold value may be a value corresponding to 33% of the percentage of the score. When the score is greater than the first threshold value and greater than a second threshold value (e.g., a value corresponding to 66% of the percentage of the score) (e.g., “No” in operation 924 and “No” in operation 925), the earpiece may increase the output volume of the ambient audio signal or reduce the playback volume of the audio content based on the measured magnitude of the ambient audio signal, the determined score, and the optionally determined direction feature value. For example, the earpiece may determine a reference value using the measured magnitude of the ambient audio signal, the determined score, and the optionally determined direction feature value, and may increase the output volume of the ambient audio signal or reduce the playback volume of the audio content based on the determined reference value.

When the score is greater than the first threshold and less than or equal to the second threshold value (e.g., “No” in operation 924 and “Yes” in operation 925), in operation 930, the earpiece may measure a detection time of the ambient audio signal. The earpiece may increase the output volume of the ambient audio signal or reduce the playback volume of the audio content based on the measured magnitude of the ambient audio signal, the determined score, the optionally determined direction feature value, and the detection time. For example, the earpiece may determine the reference value using the measured magnitude of the ambient audio signal, the determined score, the optionally determined direction feature value, and the detection time, and may increase the output volume of the ambient audio signal or reduce the playback volume of the audio content based on the determined reference value.

The earpiece according to an embodiment may determine the reference value. The earpiece may determine the reference value based on the measured magnitude of the ambient audio signal, the determined score, the measured detection time, and the direction feature value for the ambient audio signal. The reference value may be determined based on any one of Equations 9 to 13. For example, when the earpiece determines the reference value based on the measured magnitude of the ambient audio signal, the determined score, and the measured detection time, the reference value may be determined based on Equation 11. When the earpiece determines the reference value based on the measured magnitude of the ambient audio signal, the determined score, the measured detection time, and the direction feature value for the ambient audio signal, the reference value may be determined based on Equation 13. When the earpiece determines the reference value based on the measured magnitude of the ambient audio signal and the determined score, the reference value may be determined based on Equation 10, and when the earpiece determines the reference value based on the measured magnitude of the ambient audio signal, the determined score, and the direction feature value for the ambient audio signal, the reference value may be determined based on Equation 12.

The reference value may be proportional to the measured magnitude of the ambient audio signal, the determined score, or the measured detection time. When the ambient audio signal is a dangerous audio signal, the score may indicate a higher probability than a case where the ambient audio signal is not a dangerous audio signal. When the ambient audio signal is a dangerous audio signal, the magnitude of the ambient audio signal may be great and may be a relatively long audio signal, and therefore the reference value of the ambient audio signal may be proportional to the magnitude of the ambient audio signal and the measured detection time.

In general, a dangerous audio signal heard from the back of the user wearing the earpiece may be more dangerous than a dangerous audio signal heard from in front of the user. The earpiece may set the reference value to be great as the direction feature value for the ambient audio signal is great. The direction feature value is not essential for determining the reference value and may be determined optionally.

When the audio content is not being played (e.g., “No” in operation 940), in operation 945, the earpiece may adjust the output volume of the ambient audio signal. For example, when the audio content is not being played (e.g., the playback of the audio content has been stopped or terminated), the earpiece may adjust the output volume of the ambient audio signal to a first target playback volume corresponding to the determined reference value without adjusting the playback volume of the audio content. The earpiece may increase the output volume of the ambient audio signal than a volume before being adjusted to the first target playback volume by adjusting the output volume to the first target playback volume.

When the audio content is being played (e.g., “Yes” in operation 940), the earpiece may perform operation 955 of reducing the playback volume of the audio content and operation 950 of increasing the output volume of the ambient audio signal in parallel. In operation 950, the earpiece may increase the output volume of the ambient audio signal. For example, the earpiece may increase the output volume of the ambient audio signal by increasing the output volume of the ambient audio signal to the first target playback volume.

In operation 955, the earpiece may reduce the playback volume of the audio content. For example, the earpiece may reduce the playback volume of the audio content to a second target playback volume by reducing the playback volume of the audio content to the second target playback volume.

The earpiece according to an embodiment may adjust the output volume of the ambient audio signal or the playback volume of the audio content based on the reference value. The earpiece may determine the reference value based on any one of Equations 3 to 13. When the determined reference value is less than a threshold reference value (e.g., the threshold reference value of FIG. 7), the earpiece may increase the output volume of the ambient audio signal to the first target playback volume, and maintain the playback volume of the audio content.

According to an embodiment of the disclosure, when the determined reference value is greater than the threshold reference value, the earpiece may increase the output volume of the ambient audio signal to the second target playback volume corresponding to the determined reference value, and reduce the playback volume of the audio content to a third target playback volume corresponding to the determined reference value. The output volume of the ambient audio signal may increase than a volume before being adjusted to the second target playback volume by adjusting the output volume to the second target playback volume, and the playback volume of the audio content may decrease than a volume before being adjusted to the third target playback volume by adjusting the playback volume to the third target playback volume.

The earpiece may automatically detect a sound that may threaten the user's safety from the ambient audio signal and display a danger level of the detected sound as a numerical value. The earpiece may minimize disturbance to the user by adjusting at least one of the playback volume of the audio content and the output volume of the ambient audio signal based on a numerical reference value, and notify the user of the dangerous audio signal generated from the outside, thereby allowing the user to prepare for dangerous situations.

According to an embodiment of the disclosure, in a wireless audio device (120; 130; 220; 230; 301; 302) including two or more earpieces, each of the earpieces may include one or more microphones (124; 134; 320; 330; 410; 420) configured to obtain an ambient audio signal from outside of the wireless audio device (120; 130; 220; 230; 301; 302), a speaker (125; 135; 340) configured to output at least one of the obtained ambient audio signal or an audio content, memory (122; 132) including instructions, and one or more processors (121; 131) configured to execute the instructions, and the instructions, when executed by the one or more processors (121; 131), may cause the wireless audio device (120; 130; 220; 230; 301; 302) to measure a magnitude of the ambient audio signal obtained through the one or more microphones (124; 134; 320; 330; 410; 420), determine a score indicating a degree to which the ambient audio signal corresponds to a dangerous audio signal using a dangerous audio signal detection model, and increase an output volume of the ambient audio signal based on the measured magnitude of the ambient audio signal and the determined score.

The instructions, when executed by the one or more processors (121; 131), may cause the wireless audio device (120; 130; 220; 230; 301; 302) to reduce a playback volume of the audio content based on the measured magnitude of the ambient audio signal and the determined score.

The instructions, when executed by the one or more processors (121; 131), may cause the wireless audio device (120; 130; 220; 230; 301; 302) to reduce a gain of an anti-phase audio signal for the ambient audio signal output through the speaker so that the output volume of the ambient audio signal is increased.

The instructions, when executed by the one or more processors (121; 131), may cause the wireless audio device (120; 130; 220; 230; 301; 302) to increase the output volume of the ambient audio signal as the measured magnitude of the ambient audio signal is great.

The instructions, when executed by the one or more processors (121; 131), may cause the wireless audio device (120; 130; 220; 230; 301; 302) to increase the output volume of the ambient audio signal based on a ratio between the measured magnitude of the ambient audio signal and a set maximum magnitude.

The instructions, when executed by the one or more processors (121; 131), may cause the wireless audio device (120; 130; 220; 230; 301; 302) to, when the score is greater than a first threshold value and less than or equal to a second threshold value, measure a detection time during which the ambient audio signal corresponding to the score is detected, and increase the output volume of the ambient audio signal as the measured detection time is long.

The instructions, when executed by the one or more processors (121; 131), may cause the wireless audio device (120; 130; 220; 230; 301; 302) to, when the score is greater than the second threshold value, adjust at least one of a playback volume of an audio content played by the wireless audio device (120; 130; 220; 230; 301; 302) and the output volume of the ambient audio signal based on the measured magnitude of the ambient audio signal and the determined score.

The instructions, when executed by the one or more processors (121; 131), may cause the wireless audio device (120; 130; 220; 230; 301; 302) to increase the output volume of the ambient audio signal based on a ratio between the measured detection time and a set maximum detection time.

The one or more microphones (124; 134; 320; 330; 410; 420) may include a first microphone (124) configured to obtain the ambient audio signal in a first direction, and a second microphone (134) configured to obtain the ambient audio signal in a second direction different from the first direction, and the instructions, when executed by the one or more processors (121; 131), may cause the wireless audio device (120; 130; 220; 230; 301; 302) to determine a direction feature value for the ambient audio signal based on a magnitude of the ambient audio signal obtained in the first direction and a magnitude of the ambient audio signal obtained in the second direction.

The instructions, when executed by the one or more processors (121; 131), may cause the wireless audio device (120; 130; 220; 230; 301; 302) to determine a proportion of the magnitude of the ambient audio signal obtained in the first direction in a sum of the magnitude of the ambient audio signal obtained in the first direction and the magnitude of the ambient audio signal obtained in the second direction as a direction feature value for the ambient audio signal.

The instructions, when executed by the one or more processors (121; 131), may cause the wireless audio device (120; 130; 220; 230; 301; 302) to increase the output volume of the ambient audio signal based on the measured magnitude of the ambient audio signal, the determined score, and the direction feature value for the ambient audio signal.

The instructions, when executed by the one or more processors (121; 131), may cause the wireless audio device (120; 130; 220; 230; 301; 302) to increase the output volume of the ambient audio signal as the direction feature value for the ambient audio signal is great.

The output volume of the ambient audio signal may increase than a volume before being adjusted to a first target playback volume by adjusting the output volume of the ambient audio signal to the first target playback volume, and the playback volume of the audio content may decrease than a volume before being adjusted to a second target playback volume by adjusting the playback volume of the audio content to the second target playback volume.

The instructions, when executed by the one or more processors (121; 131), may cause the wireless audio device (120; 130; 220; 230; 301; 302) to adjust the output volume of the ambient audio signal to a first target playback volume based on the measured magnitude of the ambient audio signal and the determined score and maintain a playback volume of the audio content, and the output volume of the ambient audio signal may increase than a volume before being adjusted to the first target playback volume by adjusting the output volume of the ambient audio signal to the first target playback volume.

The instructions, when executed by the one or more processors (121; 131), may cause the wireless audio device (120; 130; 220; 230; 301; 302) to adjust the output volume of the ambient audio signal to a second target playback volume based on the measured magnitude of the ambient audio signal and the determined score and adjust the playback volume of the audio content to a third target playback volume, the output volume of the ambient audio signal may increase than a volume before being adjusted to the second target playback volume by adjusting the output volume of the ambient audio signal to the second target playback volume, and the playback volume of the audio content may decrease than a volume before being adjusted to the third target playback volume by adjusting the playback volume of the audio content the third target playback volume.

According to an embodiment of the disclosure, a method of operating a wireless audio device (120; 130; 220; 230; 301; 302) may include measuring a magnitude of an ambient audio signal obtained through one or more microphones (124; 134; 320; 330; 410; 420), determining a score indicating a degree to which the ambient audio signal corresponds to a dangerous audio signal using a dangerous audio signal detection model, and increasing an output volume of the ambient audio signal based on the measured magnitude of the ambient audio signal and the determined score.

The method of operating the wireless audio device (120; 130; 220; 230; 301; 302) may further include reducing a playback volume of an audio content based on the measured magnitude of the ambient audio signal and the determined score.

The method of operating the wireless audio device (120; 130; 220; 230; 301; 302) may further include, when the score is greater than a first threshold value and less than or equal to a second threshold value, measuring a detection time during which the ambient audio signal corresponding to the score is detected, and the increasing of the output volume of the ambient audio signal may include increasing the output volume of the ambient audio signal as the measured detection time is long.

The method of operating the wireless audio device (120; 130; 220; 230; 301; 302) may further include determining a direction feature value for the ambient audio signal based on a magnitude of the ambient audio signal obtained in a first direction and a magnitude of the ambient audio signal obtained in a second direction, and the increasing of the output volume of the ambient audio signal may include increasing the output volume of the ambient audio signal as the direction feature value for the ambient audio signal is great based on the measured magnitude of the ambient audio signal, the determined score, and the direction feature value for the ambient audio signal.

The electronic device according to the embodiments disclosed herein may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. As used herein, “A or B”, “at least one of A and B”, “at least one of A or B”, “A, B or C”, “at least one of A, B and C”, and “at least one of A, B, or C,” may include any one of the items listed together in the corresponding one of the phrases, or all possible combinations thereof. Terms, such as “1^{st}”, “2^{nd}”, or “first” or “second” may simply be used to distinguish the component from other components in question, and do not limit the components in other aspects (e.g., importance or order). It is to be understood that if a component (e.g., a first component) is referred to, with or without the term “operatively” or “communicatively”, as “coupled with,” “coupled to,” “connected with,” or “connected to” another component (e.g., a second component), the component may be coupled with the other component directly (e.g., by wire), wirelessly, or via a third component.

As used in connection with embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment of the disclosure, the module may be implemented in a form of an application-specific integrated circuit (ASIC).

Various embodiments of the present document may be implemented as software (e.g., a program) including one or more instructions stored in a storage medium (e.g., memory 112, memory 122, memory 132) readable by a machine (e.g., electronic device (101)). For example, a processor (e.g., the processor 111, the processor 121, or the processor 131) of the machine (e.g., the electronic device 110, the first earpiece 120, or the second earpiece 130) may invoke at least one of the one or more instructions stored in the storage medium and may execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to an embodiment of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments of the disclosure, operations performed by the module, the program, or another component may be carried out sequentially, in parallel, repeatedly, or heuristically, or one or more of the operations may be executed in a different order or omitted, or one or more other operations may be added.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing device is used as singular. however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments of the disclosure, or they may be of the kind well-known and available to those having skill in the computer software arts. Examples of non-transitory computer-readable media include magnetic media, such as hard disks, floppy disks, and magnetic tape, optical media, such as CD-ROM discs, DVDs, and/or Blue-ray discs, magneto-optical media, such as optical discs, and hardware devices that are specially configured to store and perform program instructions, such as read-only memory (ROM), random access memory (RAM), flash memory (e.g., USB flash drives, memory cards, memory sticks, or the like), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments of the disclosure, or vice versa.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wireless audio device comprising two or more earpieces,
wherein each of the earpieces comprises:
one or more microphones configured to obtain an ambient audio signal from outside of the wireless audio device;
a speaker configured to output at least one of the obtained ambient audio signal or an audio content;
memory storing one or more computer programs; and
one or more processors communicatively coupled to the one or more microphones, the speaker, and the memory, and
wherein the one or more computer programs include computer-executable instructions that, when executed by the one or more processors individually or collectively, cause the wireless audio device to:
measure a magnitude of the ambient audio signal obtained through the one or more microphones,
determine a score indicating a degree to which the ambient audio signal corresponds to a dangerous audio signal using a dangerous audio signal detection model, and
increase an output volume of the ambient audio signal based on the measured magnitude of the ambient audio signal and the determined score.

2. The wireless audio device of claim 1, wherein the one or more computer programs further include computer-executable instructions that, when executed by the one or more processors individually or collectively, cause the wireless audio device to reduce a playback volume of the audio content based on the measured magnitude of the ambient audio signal and the determined score.

3. The wireless audio device of claim 2, wherein the one or more computer programs further include computer-executable instructions that, when executed by the one or more processors individually or collectively, cause the wireless audio device to reduce a gain of an anti-phase audio signal for the ambient audio signal output through the speaker so that the output volume of the ambient audio signal is increased.

4. The wireless audio device of claim 1, wherein the one or more computer programs further include computer-executable instructions that, when executed by the one or more processors individually or collectively, cause the wireless audio device to increase the output volume of the ambient audio signal as the measured magnitude of the ambient audio signal is great.

5. The wireless audio device of claim 1, wherein the one or more computer programs further include computer-executable instructions that, when executed by the one or more processors individually or collectively, cause the wireless audio device to increase the output volume of the ambient audio signal based on a ratio between the measured magnitude of the ambient audio signal and a set maximum magnitude.

6. The wireless audio device of claim 1, wherein the one or more computer programs further include computer-executable instructions that, when executed by the one or more processors individually or collectively, cause the wireless audio device to:
when the score is greater than a first threshold value and less than or equal to a second threshold value, measure a detection time during which the ambient audio signal corresponding to the score is detected, and
increase the output volume of the ambient audio signal as the measured detection time is long.

7. The wireless audio device of claim 6, wherein the one or more computer programs further include computer-executable instructions that, when executed by the one or more processors individually or collectively, cause the wireless audio device to, when the score is greater than the second threshold value, adjust at least one of a playback volume of an audio content played by the wireless audio device and the output volume of the ambient audio signal based on the measured magnitude of the ambient audio signal and the determined score.

8. The wireless audio device of claim 6, wherein the one or more computer programs further include computer-executable instructions that, when executed by the one or more processors individually or collectively, cause the wireless audio device to increase the output volume of the ambient audio signal based on a ratio between the measured detection time and a set maximum detection time.

9. The wireless audio device of claim 1,
wherein the one or more microphones comprise:
a first microphone configured to obtain the ambient audio signal in a first direction, and
a second microphone configured to obtain the ambient audio signal in a second direction different from the first direction, and
wherein the one or more computer programs further include computer-executable instructions that, when executed by the one or more processors individually or collectively, cause the wireless audio device to determine a direction feature value for the ambient audio signal based on a magnitude of the ambient audio signal obtained in the first direction and a magnitude of the ambient audio signal obtained in the second direction.

10. The wireless audio device of claim 9, wherein the one or more computer programs further include computer-executable instructions that, when executed by the one or more processors individually or collectively, cause the wireless audio device to determine a proportion of the magnitude of the ambient audio signal obtained in the first direction in a sum of the magnitude of the ambient audio signal obtained in the first direction and the magnitude of the ambient audio signal obtained in the second direction as a direction feature value for the ambient audio signal.

11. The wireless audio device of claim 9, wherein the one or more computer programs further include computer-executable instructions that, when executed by the one or more processors individually or collectively, cause the wireless audio device to increase the output volume of the ambient audio signal based on the measured magnitude of the ambient audio signal, the determined score, and the direction feature value for the ambient audio signal.

12. The wireless audio device of claim 9, wherein the one or more computer programs further include computer-executable instructions that, when executed by the one or more processors individually or collectively, cause the wireless audio device to increase the output volume of the ambient audio signal as the direction feature value for the ambient audio signal is great.

13. The wireless audio device of claim 2,
wherein the output volume of the ambient audio signal increases than a volume before being adjusted to a first target playback volume by adjusting the output volume of the ambient audio signal to the first target playback volume, and
wherein the playback volume of the audio content decreases than a volume before being adjusted to a second target playback volume by adjusting the playback volume of the audio content to the second target playback volume.

14. The wireless audio device of claim 1,
wherein the one or more computer programs further include computer-executable instructions that, when executed by the one or more processors individually or collectively, cause the wireless audio device to adjust the output volume of the ambient audio signal to a first target playback volume based on the measured magnitude of the ambient audio signal and the determined score and maintain a playback volume of the audio content, and
wherein the output volume of the ambient audio signal increases than a volume before being adjusted to the first target playback volume by adjusting the output volume of the ambient audio signal to the first target playback volume.

15. The wireless audio device of claim 14,
wherein the one or more computer programs further include computer-executable instructions that, when executed by the one or more processors individually or collectively, cause the wireless audio device to:
adjust the output volume of the ambient audio signal to a second target playback volume based on the measured magnitude of the ambient audio signal and the determined score, and
adjust the playback volume of the audio content to a third target playback volume,
wherein the output volume of the ambient audio signal increases than a volume before being adjusted to the second target playback volume by adjusting the output volume of the ambient audio signal to the second target playback volume, and
wherein a playback volume of the audio content decreases than a volume before being adjusted to the third target playback volume by adjusting the playback volume of the audio content to the third target playback volume.

16. A method of operating a wireless audio device, the method comprising:
measuring a magnitude of an ambient audio signal obtained through one or more microphones;
determining a score indicating a degree to which the ambient audio signal corresponds to a dangerous audio signal using a dangerous audio signal detection model; and
increasing an output volume of the ambient audio signal based on the measured magnitude of the ambient audio signal and the determined score.

17. The method of claim 16, further comprising:
reducing a playback volume of an audio content based on the measured magnitude of the ambient audio signal and the determined score.

18. The method of claim 16, further comprising:
when the score is greater than a first threshold value and less than or equal to a second threshold value, measuring a detection time during which the ambient audio signal corresponding to the score is detected,
wherein the increasing of the output volume of the ambient audio signal comprises increasing the output volume of the ambient audio signal as the measured detection time is long.

19. The method of claim 16, further comprising:
determining a direction feature value for the ambient audio signal based on a magnitude of the ambient audio signal obtained in a first direction and a magnitude of the ambient audio signal obtained in a second direction,
wherein the increasing of the output volume of the ambient audio signal comprises increasing the output volume of the ambient audio signal as the direction feature value for the ambient audio signal is great based on the measured magnitude of the ambient audio signal, the determined score, and the direction feature value for the ambient audio signal.

20. One or more non-transitory computer-readable storage media storing one or more computer programs including computer-executable instructions that, when executed by one or more processors of a wireless audio device individually or collectively, cause the wireless audio device to perform operations, the operations comprising:
measuring a magnitude of an ambient audio signal obtained through one or more microphones;
determining a score indicating a degree to which the ambient audio signal corresponds to a dangerous audio signal using a dangerous audio signal detection model; and
increasing an output volume of the ambient audio signal based on the measured magnitude of the ambient audio signal and the determined score.
